(19) United States
(12) Patent Application Publication
(10) Pub. No.: US 2012/0020097 A1
(43) Pub. Date: Jan. 26, 2012

(54) LAMP WITH A ROTATABLE LIGHT BULB AND A LIGHT SOURCE

(76) Inventor: Victor Ivanovich Tsay, Moscow (RU)

(21) Appl. No.: 12/277,210

(22) Filed: Nov. 24, 2008

(30) Foreign Application Priority Data
May 26, 2006 (RU) PCT/RU2006/000271

(51) Int. Cl. F21V 19/02

(52) U.S. Cl. 362/418

(57) ABSTRACT

The invention relates to electrical engineering. The aim of said invention is to reduce the production cost of a lamp and to improve the quality thereof. The inventive lamp comprises a rotatable light bulb, a light source arranged therein, a socket consisting of internal and external components connected by a retainer, a latch for preventing the socket components from rotating into each other in the same direction and an insulator which is provided with contacting plate and fixed to the internal component of the socket. The retainer is made from a spring wire in the form of an open ring, and is located in a groove, which is embodied on the side surface of the insulator, and is placed on a curved end surface of the internal component of the socket.

### CROSS-REFERENCE TO RELATED APPLICATION

This application claims the benefit of the priority filing date in PCT/RU2006/000271 referenced in WIPO Publication WO/2007/139419. The earliest priority date claimed is May 26, 2006.

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The claimed invention pertains to the electric power industry. In particular, it improves the design of gas-discharge reflector lamps for general and special lighting.

Known in the art is a lamp with a rotating bulb and emitter comprising an emitter installed in a bulb and a base attached to the bulb (USSR Certificate of Authorship No. 1636896 Al, 03.23.91).

The shortcoming of the technical solution is the inability to change the location of the emitter installed in the bulb relative to the bulb axis, which considerably reduces the lamp's operational capability. Using the lamp in a lighting fixture that has a reflector and a socket for the lamp base does not make it possible to change the light distribution curve of the lighting fixture.

When using lamps with a reflective surface on the bulb, it is necessary to use a special focusing socket, instead of the widely-used threaded socket, and attach a special base to the lamp. This creates huge operational expenditures and does not completely solve the problem of lamp emission in a certain direction.

The closest to solving this problem in the technical field is a lamp with a rotating bulb and emitter comprising an emitter installed in a bulb, and a base attached to the bulb. The base consists of the internal and external parts connected by means of a retainer, a latch that prevents base parts from turning inside each other in one of the directions, and an insulator with a contact plate attached to the base's internal part (Reflux company advertising, drawing [symbol] .675721.038C [symbol] ). This technical solution, used as the prototype, makes it possible to change the direction of emission using the lamp in lighting fixtures having a standard socket for a threaded base.

The prototype's shortcomings are high lamp costs due to the complexity of assembling the base and the high probability of losing reliable electric contact between the internal and external base parts when screwing the base into a socket. When the base is screwed into a socket, as one turns the lamp to achieve a certain direction of emission, the insulator with a contact plate stops against the base contact, and forces are applied to the internal and external parts of the base in mutually opposite directions. The edges of the fastener, having the shape of a formed ring with end faces of the base's internal and external parts located between the ring edges, are unbent by the forces. In the process, the contact between the base parts is lost.

The invention's objective is to reduce the lamp's cost and improve their quality.

The stated objective is achieved in the case of a lamp with a rotating bulb and emitter comprising an emitter installed in a bulb, by attaching a base to the bulb consisting of internal and external parts connected by means of a retainer, a latch that prevents base parts from turning inside each other in one of the directions, and an insulator with a contact plate attached to the base's internal part, the retainer being made of spring wire in the shape of an open polygonal ring placed in a slot made in the insulator's side surface and located on the bent end face surface of the base's internal part.

### SUMMARY

The invention relates to gas-discharge reflector lamps for general and special lighting.

In the case of a lamp with a rotating bulb and emitter comprising an emitter installed in a bulb, lamp costs and quality are improved by attaching a base to the bulb consisting of internal and external parts connected by means of a retainer, a latch that prevents base parts from turning inside each other in one of the directions, and an insulator with a contact plate attached to the base's internal part, the retainer being made of spring wire in the shape of an open polygonal ring placed in a slot made in the insulator's side surface and located on the bent end face surface of the base's internal part.

### FIGURES

FIG. 1 shows the general view of the lamp with a reflecting surface indicated by dashes on the bulb. Burner 1 is installed in bulb 2 to which rotating base 3 is attached.

FIG. 2 shows the base comprised of internal part 4 and external threaded part 5 connected by means of a retainer 6. The latch is comprised of bent tongue 7 and groove 8 located at the same level in different base areas. When the lamp is screwed into a socket, the tongue slides in one of the directions in the groove, and does not prevent the base's internal part from turning relative to the external part. When the lamp is unscrewed from the socket, the tongue enters the groove, preventing the base's internal part from turning relative to the external part. The base is unscrewed from the socket. Insulator 9 with contact plate 10 is attached to the base's internal part by means of bulges 11 made on the base's internal part facing inside the base. Retainer 6 shown in section A-A is made of spring wire in the shape of an open polygonal ring. The retainer is placed in slot 12 on the insulator's side surface, and is located on the unbent face of the base's 13 external part.

FIG. 3 shows insulator 9 with side slot 12.

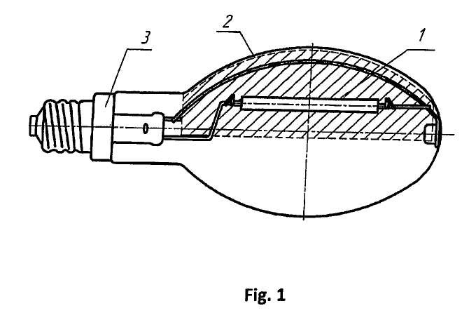

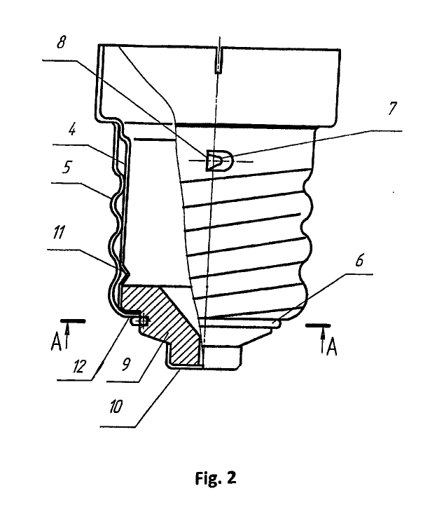

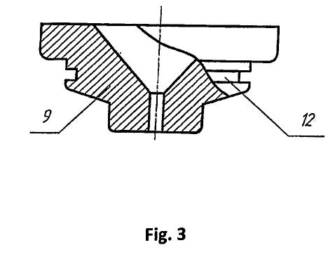

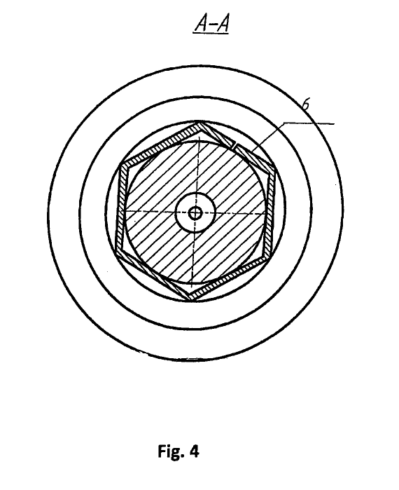

### DESCRIPTION

The depth of the insulator slot must be as low as possible. It is selected based on its ability to reliably retain and hold against any axial load applied to the base's internal and external parts when the lamp base is installed and removed from a lighting fixture.

The assembly and base installation on the lamp is performed as follows: An insulator is installed in the base's internal cylindrical part until it rests against the end face, and fastened by means of bulges made on the base's internal part facing inside the base. Then, the threaded external part is placed over the internal cylindrical part as far as it will go, and fastened by means of a retainer that is placed in the insulator slot and that firmly holds the assembled base. After assembling, the base is attached to the lamp, current leads are welded to the base's internal part, and the contact plate is fastened to the insulator.

When the lamp is screwed into a socket and the insulator with the contact plate stops against the socket contact, one keeps turning the lamp to achieve a certain direction of lamp emission. The external part stops, but the internal part keeps turning with the bulb until the required position is reached. The retainer, resting against the end face of the base's external part, presses the external part against the internal part and does not disturb the reliable contact of the base parts. If necessary, the lamp can be turned several times about its axis to reach the required position. The tongue on the inside surface slides into the groove without preventing the base's internal part from turning relative to the external part.

When the lamp is unscrewed from the socket, the tongue enters the groove, preventing the base's internal part from turning relative to the external part, and the base is unscrewed from the socket.

In accordance with the application description, a batch of lamps with sodium-vapor burners, 250 capacity, with a 120 mm ellipsoidal bulb and a reflective surface applied to the bulb inside was made. The retainer was made of a 1.5 mm diameter spring wire tests that were conducted demonstrated there was no loss of contact between the base's internal and external parts. The labor intensity of base assembly and lamp manufacturing is substantially lower.

The use of the claimed invention in manufacturing sodium-vapor reflector lamps will reduce lamps cost while preserving all of their consumer properties.

What is claimed is:

1. A lamp with a rotating bulb and emitter, comprising
an emitter installed in a bulb,
a base attached to the bulb and consisting of the internal and external parts connected by means of a retainer,
a latch that prevents base parts from turning inside each other in one of the directions, and
an insulator with a contact plate attached to the base's internal part,
the retainer being made of spring wire in the shape of an open polygonal ring placed in a slot made in the insulator's side surface and located on the bent end face surface of the base's internal part.
